(19) United States
(12) Patent Application Publication
(10) Pub. No.: US 2022/0354326 A1
(43) Pub. Date: Nov. 10, 2022

(54) VACUUM-CLEANER FILTER BAG FOR A HAND-HELD VACUUM CLEANER

(71) Applicant: EUROFILTERS HOLDING N.V., Overpelt (BE)

(72) Inventors: Ralf SAUER, Overpelt (BE); Jan SCHULTINK, Overpelt (BE)

(21) Appl. No.: 17/619,086

(22) PCT Filed: Jun. 15, 2020
(86) PCT No.: PCT/EP2020/066464

§ 371 Date: Dec. 14, 2021

(30) Foreign Application Priority Data
Jun. 17, 2019 (EP) 19180533.2

(51) Int. Cl. A47L 9/14

(52) U.S. Cl. CPC A47L 9/14

(57) ABSTRACT

The invention comprises a vacuum cleaner filter bag comprising a base element, a cover element having an inflow opening and a retaining plate surrounding the inflow opening at least in part is connected to the cover element, and at least four intermediate elements which are arranged between the base element and the cover element and each comprise a passage opening aligned with the inflow opening of the cover element, where the intermediate elements are configured as filter elements and each comprise nonwoven fabric and/or fibrous nonwoven, where the intermediate element directly adjoining the base element is connected to the base element along the outer edge of the intermediate element or along the edge of the passage opening, and where adjacent intermediate elements are connected to each other alternately along the edge of the passage openings and along their outer edge.

The invention relates to a vacuum cleaner filter bag, in particular a vacuum cleaner filter bag for a hand-held vacuum cleaner and/or a so-called stick vacuum cleaner, in particular for cordless models.

Stick vacuum cleaners are mostly, but not always, cordless devices (battery vacuum cleaners) in which an electric brush is connected to the actual housing of the hand-held vacuum cleaner via a suction tube without a suction hose. These devices are very light and handy. The sticks have low power consumption in the range of around 150 to 600 W. The volume flows achieved are correspondingly low and are in the order of magnitude of 10 to 30 l/s. The filter housing is typically cylindrical and has a small volume (approx. 1 to 2 liters). A cyclone separator is commonly used as the filter. The cyclone separator accelerates the suction air and the particles contained therein. As a result, a considerable part of the available power is consumed and there is only little power left for generating a sufficient volume flow. The cleaning effect (dust collection) is often unsatisfactory.

A filter bag made from modern nonwoven fabric laminates is much more energy efficient in separating dust. However, it is difficult to produce a filter bag that fits perfectly into the very small space available and provides a sufficient filter surface.

In addition, simple handling is particularly important with such hand-held devices, and already when inserting the empty filter bags as well as when removing the filled filter bags.

An important aspect of filter bags with folds, such as side-gusseted bags, is the functionally reliable unfolding of the bag in the installation space of the vacuum cleaner. A side gusseted bag is typically delivered in the folded state. The bag is placed into the device also in the folded state. The unfolding is often difficult and the bag surface then remains unused for the filtration because of incomplete unfolding.

The expansion caused by the filling of a bag often leads to the bag resting against the housing wall and/or jamming between housing ribs. Removal then becomes difficult. The simplest possible removal is desired. It would be ideal if the bag could be poured out after opening the housing—without having to touch it.

Filter bags that are suitable for installation spaces having a wide variety of geometries are also needed. This can be e.g. cylindrical, cuboid and designs with oval cross sections.

The object of the invention is therefore to provide an easy-to-handle vacuum cleaner filter bag, in particular a vacuum cleaner filter bag for a handheld vacuum cleaner and/or a stick vacuum cleaner, which uses the available installation space as optimally as possible and provides a sufficient filter surface.

This object is satisfied by a vacuum cleaner filter bag according to claim 1. Particularly advantageous developments can be found in the dependent claims.

The invention therefore provides a vacuum cleaner filter bag comprising a base element, a cover element, where an inflow opening is provided in the cover element and a retaining plate surrounding the inflow opening at least in part is connected to the cover element, and at least four Intermediate elements which are arranged between the base element and the cover element and each comprise a passage opening which is in alignment with the inflow opening of the cover element, where the intermediate elements are configured as filter elements and each comprise nonwoven fabric and/or fibrous nonwoven, where the intermediate element directly adjoining the base element is connected to the base element along the outer edge of the intermediate element or along the edge of the passage opening, and where adjacent intermediate elements are connected to each other alternately along the edge of the passage openings and along their outer edge.

The intermediate elements are therefore alternately connected at their outer edge and at the inner edge of the passage hole, so that a zigzag folding of the bag wall arises. This enables the expansion in the axial direction, meaning along the axis which is defined by the center points of the inflow opening and the passage openings. The expansion in the axial direction takes place by the fold sides folding apart, i.e. that region of intermediate elements 4 which is disposed between the connection at the outer edge of the intermediate elements and the connection at the edge of the passage opening. In the radial direction, however, the bag is fixed so that it cannot expand in the radial direction. As a result, both the insertion and the removal of the bag is very easy since the diameter of the bag does not increase during use. The bag can be folded together to save space and it unfolds automatically and only in the axial direction. It is not necessary to unfold it before insertion. As a result of the folding, however, the largest possible filter surface can be made available. In addition, the geometry of the bag can be determined by the geometry of the intermediate elements, the base element, and the cover element, so that the available installation space can be used as optimally as possible.

The invention can be provided in particular for a hand-held vacuum cleaner and/or a so-called stick vacuum cleaner, in particular for cordless models. The filling volume in the fully unfolded state can therefore be between 0.5 and 3 liters, in particular between 0.5 and 2 liters.

The intermediate elements can be designed to be congruent. Likewise, the cover element can be designed to be congruent with the intermediate elements. Finally, the outer contour of the base element can also correspond to that of the cover element and the intermediate elements. This allows geometrically simple bags to be provided.

However, it is also conceivable that more complex bag shapes can be realized by combining different diameters or shapes, respectively. For example, conical bags or asymmetrical shapes can be formed.

The base element can be impermeable to air and/or have a surface profile, in particular one or more elevations, on the side facing away from the interior of the bag. The profile on the base element can assist guiding the air to the suction opening of the motor, or to space the plastic disk at least in part from the base. With such hand-held vacuum cleaners. the suction opening is often located at the base of the installation space that is provided for receiving the filter bag. A base element impermeable to air can prevent the main air flow from reaching the suction opening directly through the base element. Instead, the larger side wall of the bag formed by the intermediate elements can be used for filtration.

The base element can be made of, for example, plastic material or card board.

However, it is also possible to form the base element from filter material, in particular from a material used for one or more intermediate elements.

The intermediate elements comprise material that is permeable to air and are designed in particular as filter elements. The intermediate elements can be constructed having several layers. This is also referred to as a laminate. Several layers of the laminate, in particular each layer of the laminate, can comprise or consist of nonwoven fabric and/or of fibrous nonwoven.

The intermediate elements can in principle also be made up of different laminates. For example, the permeability to air in the lower region of the bag can be set to be different than in the upper region. This is of interest, e.g., for conical bags.

The unfolding or the filling behavior of the bag can also be influenced in this way.

A wide variety of plastic materials can be used as the material for the intermediate elements, for example, polypropylene and/or polyester. The intermediate elements can also comprise or consist of plastic recyclate and/or recycled material from the manufacture of textiles (textile-left-overs—TLO).

There are relevant international standards that exist for many plastic recyclates. For example, DIN EN 15353: 2007 is relevant for PET plastic recyclates PP recyclates are characterized in DIN EN 15345: 2008. The present patent application adopts the definitions of these international standards for the purpose of the corresponding special plastic recyclates. The plastic recyclates can there be unmetallized. An example of this are plastic flakes or chips recovered from PET beverage bottles. The plastic recyclates can also be metallized, e.g. if the recyclates were obtained from metallic plastic films, in particular metallized PET films (MPET).

Recycled polyethylene terephthalate (rPET) can be obtained, for example, from beverage bottles, in particular from so-called bottle flakes, i.e. pieces of ground beverage bottles.

The recycled plastic materials, in particular recycled PET and/or recycled PP, both in the metallized and in the non-metallized form, can be spun to form the respective fibers from which the corresponding staple fibers or meltblown or spunbond nonwoven fabrics are made for the purposes of the present invention.

Recycled material from the manufacture of textiles (TLO) accrues in particular in the processing of textile materials (especially textile fibers and filaments, as well as linear, two-dimensional, and spatial textile structures produced therewith), such as the manufacture (comprising carding, spinning, cutting and drying) or the recycling of textile materials. These pulverulent and/or fibrous materials represent waste materials that can settle on the machines or filter materials used to process the textiles. The dusts (powder) or fibers are normally disposed of and thermally recycled.

The pulverulent and/or fibrous recycled material is therefore, for example, production waste; this is true in particular for material that is produced as a waste product when carding, spinning, cutting or drying textile materials. This is also referred to as pre-consumer waste.

In the recycling of textile materials, i.e. the processing (e.g. shredding) of used textile materials or textiles (e.g. old clothes), pulverulent and/or fibrous recycled material is likewise produced; this is referred to as post-consumer waste.

The recycled material from the manufacture of textiles, TLO, can therefore comprise in particular fibers and or filaments that are obtained from waste materials from the textile and clothing industry, from post-consumer waste (textiles and the like), and/or from products that were collected for recycling.

In the context of the present invention, a nonwoven fabric denotes a random scrim that has undergone a consolidation step so that it has sufficient strength, for example, to be wound to or unwound from rolls by machine (i.e. on an industrial scale). The minimum web tension required for winding is 0.044 N/mm. The web tension should not be higher than 10% to 25% of the minimum maximum tensile force (according to DIN EN 29073-3: 1992-08) of the material to be wound. This results in a minimum maximum tensile force for a material to be wound up of 8.8 N per 5 cm strip width.

Fibrous nonwoven, or simply nonwoven for short, corresponds to a random scrim which, however, has not undergone a consolidation step, so that, in contrast to a nonwoven fabric, such a random scrim does not have sufficient strength, for example, to be wound into rolls or unwound mechanically.

The term nonwoven is used in other words according to the definition according to ISO standard ISO9092: 1988 or CEM standard EN29092. Details on the use of the definitions and/or methods described herein can also be found in the standard work “Vliesstoffe”, W. Albrecht, H. Fuchs, W. Kittelmann, Wiley-VCH, 2000.

Both non-woven fabric as well as fibrous non-woven can be used for the intermediate elements.

The intermediate elements can comprise in particular staple fiber nonwoven fabric and/or extruded nonwoven fabric. In particular, filament spunbond nonwoven fabric (also known as spunbond for short) and/or meltblown nonwoven fabric can be used.

The intermediate elements can comprise carded material. Mechanical processes (e.g. needling) as well as thermal processes (e.g. calendering) can be used as the bonding step. It is also possible to use bonding fibers or adhesives, such as latex adhesive. Airlaid materials are also possible.

The nonwoven fabric of the intermediate layers can comprise bicomponent fibers. Bicomponent fibers (BiCo fibers) can be formed from a core and a sheath enveloping the core. In addition to core/sheath bicomponent fibers, the other common variants of bicomponent fibers can be used, e.g. side-by-side.

The bicomponent fibers can be present as staple fibers or as filaments in the case of extruded nonwoven fabric (for example meltblown nonwoven fabric).

Accordingly unconsolidated fibrous nonwovens are also conceivable, as mentioned.

The intermediate elements can each comprise, in particular, a capacitance layer A capacitance layer provides high resistance to shock loading and enables filtering large dirt particles, filtering a significant proportion of small dust particles, and the storage or retention of large amounts of particles, where the air is allowed to easily flow through, and a smaller pressure drop therefore arises with a high particle load.

The intermediate elements can also each comprise a fine filter layer. A fine filter layer is used to increase the filtration performance of the multi-layer filter material by trapping particles which, for example, pass through the protective layer and/or the capacitance layer. To further increase the separation performance, the fine filter layer can preferably be charged electrostatically (e.g. by corona discharge or hydrocharging), in particular to increase the separation of fine dust particles.

The fine filter layer can in particular adjoin the capacitance layer towards the outside of the bag wall.

A support layer can further adjoin the fine filter layer. A support layer (sometimes also referred to as a “reinforcement layer”) is a layer that gives the multilayer laminate of the filter material the necessary mechanical strength. The support layer can be in particular open porous nonwoven fabric with a low mass per unit area. The support layer can be in particular spunbond nonwoven fabric.

But it is also possible to use single-layer filter material for the intermediate elements. In this case, this can be in particular meltblown nonwoven fabric. A suitable material for such a single-layer bag wall is known, for example, from EP 2 311 360 B1.

The cover element and/or the base element can also be designed as filter elements. They can then have one or more of the features just disclosed for the intermediate elements.

According to a simple example, the intermediate elements, the base element, and the cover element can be made of the same material.

The ratio of the maximum expansion of the intermediate elements to the diameter of the respective passage opening can be at most 4, in particular at most 3. The bag can therefore be formed to be quite compact. The relatively large passage openings make it possible to distribute the dust evenly in the bag.

The diameter of the passage openings of the intermediate elements can be at least 2 cm, in particular at least 5 cm. The diameter of the passage openings of the intermediate elements can be in particular equal to the diameter of the inflow opening of the cover element.

The maximum expansion of the intermediate elements can be less than 20 cm, in particular less than 15 cm. In the case of circular disks as intermediate elements, the maximum expansion of the intermediate elements corresponds to the (constant) diameter.

All intermediate elements can be structured in the same way. However, it is also conceivable that at least two intermediate elements have a different structure.

The intermediate elements can be disk-shaped, in particular with a circular, oval, or angular cross section. A disk is presently understood to be a geometric body in the form of a cylinder, the maximum radial extension of which is many times greater than its axial thickness. The intermediate elements then extend predominantly in one plane.

The intermediate elements, however, can also have a three-dimensional, 3-D, shape. This means that the intermediate elements not only extend in a main plane, with a certain material thickness perpendicular thereto, but that they have a predetermined shape which also extends outside this main plane. The intermediate elements can be curved, for example, to be convex or concave. The edge of the intermediate elements can be configured so as not to be curved, i.e. be planar. In illustrative terms, they can be bowl-shaped or plate-shaped, each with or without an edge.

It is also possible that an inner radial region of the curved intermediate elements is configured to be corrugated. The edge region can be formed to be flat, i.e. not curved. This provides a defined contact surface. It is also possible to introduce elevations and depressions on the surface of the contact region, i.e. in the connecting region of the intermediate elements. This allows for the welding and/or adhesive bonding to be optimized. The transition from the edge to the inner region can be effected at various angles or radii. In illustrative terms, different heights of the bowls, plates, or cups can be realized. The structuring of the intermediate elements can be in particular implemented by embossing.

The base element can be formed to be transparent. This makes it possible to determine how much suction material has already accumulated in the bag.

The retaining plate of the vacuum cleaner filter bag, which surrounds the inflow opening of the cover element at least in part, can be attached to a retaining device in a vacuum cleaner housing. As a result, the retaining plate can be arranged, in particular an affixable manner, in a predetermined position in the vacuum cleaner housing. The retaining plate can have a passage opening which is in alignment with the inflow opening of the cover element, so that the air to be cleaned can flow into the interior of the vacuum cleaner filter bag.

The retaining plate can comprise plastic material or be made of one or more plastic materials. In particular, recycled plastic materials can be used, such as recycled polypropylene, rPP, and/or recycled polyethylene terephthalate, rPET.

The retaining plate can comprise a closure element for closing the inflow opening. As a result, the suction material can be retained in the interior of the bag, in particular when the bag is removed.

The intermediate elements can be configured to be different, in particular comprise different materials and/or have different material parameters. The resulting different filter properties can be advantageous for facilitating certain flow paths or for making them more difficult. For example, the thickness, the grammage, and/or the permeability to air can be used as material parameters. As mentioned above, the intermediate elements can also differ in their structure.

The connection of the intermediate elements to one another or to the base element and the cover element can be effected by way of adhesive bonding and/or welding. The elements can therefore be adhesively bonded and/or welded accordingly. It is also conceivable that the elements are welded along the outer edge and adhesively bonded along the edge of the passage openings, or vice versa.

It is advantageous to pre-compact the materials in the region of the welding and/or adhesive bond. This means that the materials are pressed under the action of heat or ultrasound and then form a compacted structure.

Adhesive bonding can be by way of hot melt adhesive and welding by way of ultrasonic welding. Other welding processes are also possible for some plastic materials. For example, high-frequency welding and/or rotary friction welding can also be used. High-frequency welding can be an advantageous variant in particular for polyethylene terephthalate, PET—also in the context of TLO.

The invention also provides a method for the manufacture a vacuum cleaner filter bag according to claim 12, in particular for the manufacture a vacuum cleaner filter bag as described above.

The method can comprise providing a cover element, where an inflow opening is provided in the cover element, and connecting the cover element to a second of the intermediate elements so that the inflow opening is in alignment with the passage opening of the intermediate element.

The method can also comprise pre-compacting the connecting regions of the intermediate elements, the base element, and/or the cover element. This enables a stronger connection to be achieved. Pre-compacting can be carried out by ultrasonic welding, thermal welding, or by applying pressure.

The intermediate elements can first be connected to one another in pairs along their outer edge without the first and the second intermediate elements and the intermediate elements connected in pairs can be connected along the edge of the passage openings among each other or to the first or second intermediate element.

The method can also comprise arranging two filter material elements one above the other. This can be done by folding a web of filter material. Alternatively, two filter material webs can also be unwound on top of one another.

In the case of laminates that comprise a capacitive layer, the webs can be superimposed such that the capacitive layers face one another.

In the case of the intermediate elements to be formed without the first and the second intermediate element, a passage opening can be punched into both filter material elements The two filter material elements can be connected to one another by welding the outer contour of the later intermediate elements. The welding region can be pre-compacted.

The welded filter material elements can then be punched along the welded contours so that intermediate elements connected in pairs are obtained. It is also conceivable to perform the punching prior to the connection and/or to use adhesive instead of a weld for the connection.

The number of pairs of interconnected intermediate element required for the bag shape are connected one after the other. The connecting region can again be pre-compacted.

Finally, the base element and the first intermediate element connected thereto as well as the cover element and the second intermediate element connected thereto can be connected to the pairs of intermediate elements connected to one another.

Further features and advantages of the invention shall be described hereafter with reference to the exemplary figures, where:

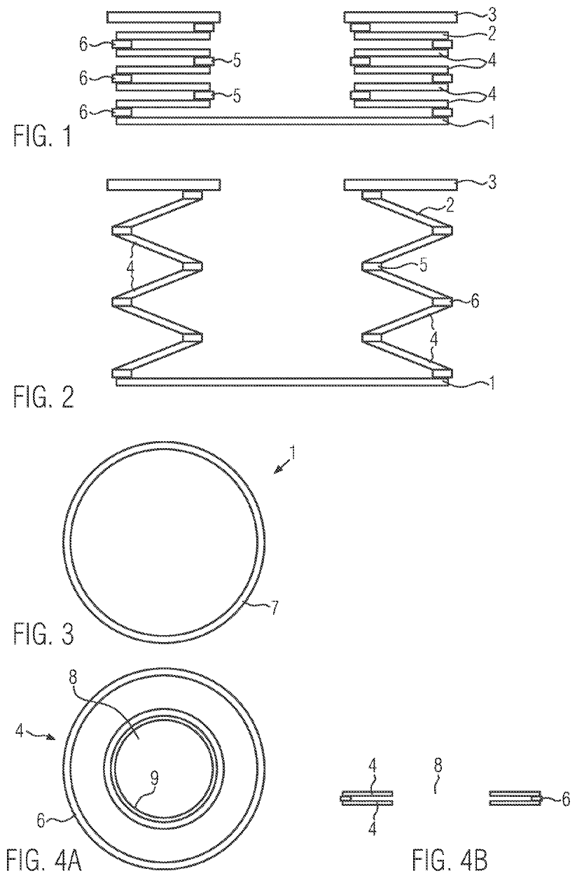

FIG. 1 shows a cross section through an exemplary vacuum cleaner filter bag when folded up;

FIG. 2 shows a cross section through an exemplary vacuum cleaner filter bag when unfolded;

FIG. 3 shows a base element of an exemplary vacuum cleaner filter bag; and

FIGS. 4A and 4B show a top view onto and a cross section through intermediate elements of an exemplary vacuum cleaner filter bag.

FIG. 1 shows a cross section through an exemplary vacuum cleaner filter bag when folded up. The vacuum cleaner filter bag comprises a base element 1 which in the simplest example is a filter element, but can also be formed to be impermeable to air. The exemplary base element 1 has the shape of a circular disk.

The bag also comprises a cover element 2 which comprises an inflow opening in the form of a central passage hole and can likewise be configured as a filter element. A retaining plate 3 is connected, in particular welded or adhesively bonded, to the cover element. Retaining plate 3 is used to affix the vacuum cleaner filter bag in a corresponding retainer in a housing of a vacuum cleaner. Retaining plate 3 comprises a passage hole which is in alignment with the inflow opening of cover element 2.

Finally, four intermediate elements 4 are provided which are arranged between base element 1 and cover element 2 and each comprise a passage opening which is in alignment with the inflow opening of cover element 2.

Intermediate elements 4 are configured as filter elements and each comprise nonwoven fabric and/or fibrous nonwoven.

Intermediate element 4 directly adjoining base element 1 is connected to base element 1 along the outer edge of intermediate element 4. Connection 6 can be realized as a welded connection or an adhesive connection.

Intermediate element 4 directly adjoining cover element 2 is connected to cover element 2 likewise along the outer edge of intermediate element 4. Connection 6 can again be realized as a welded connection or an adhesive connection.

Therebetween, adjacent intermediate elements 4 are connected to one another alternately along the edge of the passage openings and along their outer edge, so that a zigzag fold is formed. Connection 5 along the edge of the passage openings can again be realized as a welded connection or an adhesive connection. In other words, each intermediate element 4 is connected to an adjacent intermediate element 4 along their outer edge and to another intermediate element along the edge of the passage openings. The result is a vacuum cleaner filter bag whose shape resembles a bellows.

In the folded state, the intermediate layers are arranged approximately in parallel.

When the filter bag is inserted into the corresponding installation space of a vacuum cleaner, it unfolds automatically due to the action of gravity and/or due to the suction airflow, but only in the axial direction, i.e. along the longitudinal axis of the bag. This is illustrated in FIG. 2. The fold sides flip open so that the bag extends in the longitudinal direction. The centers of the passage openings of intermediate elements 4 and the centers of the inflow openings of cover element 2 and retaining plate 3 are disposed on this longitudinal axis. The bag does not expand in the radial direction, i.e. perpendicular to the longitudinal axis, since the zigzag folds are affixed at connections 5, 6.

The vacuum cleaner filter bag thus obtained is particularly suitable for a hand-held vacuum cleaner and in particular so-called stick vacuum cleaners, in particular for cordless battery vacuum cleaners. Due to the fact that the vacuum cleaner filter bag does not expand in the radial direction during operation, it can be easily removed from the vacuum cleaner. Ideally, the container of the vacuum cleaner in which the bag is located only needs to be tilted to the extent that the bag drops out due to the effect of gravity.

The achievable length of the vacuum cleaner filter bag depends on the number of folds and the depth of the folds, it can therefore be precisely determined in advance and adapted to the installation space of the vacuum cleaner. In the example of FIGS. 1 and 2, two folds are provided between base element 1 and cover element 2. But it is also conceivable to form more than these two folds. For example, 6 to 8 folds can be formed. In this case, more than four intermediate elements 4 are required accordingly. The diameter of the passage openings of intermediate elements 4 together with their outer diameter again determines the depth of the folds. With a larger number of folds, the thickness of the intermediate layers can be reduced in order to reduce the package size.

FIG. 3 shows an exemplary base element 1 as can be used for a bag shown in FIGS. 1 and 2. This base element 1 in the form of a circular disk can be made of filter material. But it can also be configured as a plastic or cardboard disk. In the case of a plastic disk, it can also be transparent. Base element 1 can have a profile for guiding the air to the intake opening of the motor or for spacing base element 1 at least in part from the base of the receiving region of the vacuum cleaner.

Outer edge 7 of base element 1 can be pre-compacted, for example, by ultrasonic welding, thermal welding, or by applying pressure.

FIG. 4A shows an exemplary intermediate element 4 in a top view. It is presently configured as a circular ring with a passage opening 8 at the center. Edge 9 of passage opening 8 can again be pre-compacted.

A first such intermediate element 4 can be connected, for example, along the outer edge to base element 1 of FIG. 3 by way of a connection 6. An adjoining further such intermediate element 4 can be provided, where intermediate elements 4 are connected to inner edge 9 of passage openings 8. This is again followed by such an intermediate element 4 which is connected to the outer edge of previous intermediate element 4. This continues until a bag, for example, as shown in FIGS. 1 and 2 is obtained.

In principle, it would also be possible to connect the first intermediate element along edge 9 of passage opening 8 to the base element. In this case, the connection to next intermediate element 4 is effected via the outer edge of intermediate elements 4.

Instead of the above-described sequential connection of intermediate elements 4, intermediate elements 4 can also first be connected in pairs. A cross section for such a double ring structure is shown in FIG. 4B.

One or more such double rings can then be adhesively bonded one after the other to a structure composed of base element 1 and first intermediate element 4. The connection is respectively effected at the edge of passage openings 8. Finally, a structure of cover element 2 and second intermediate element 4 follows.

In the simplest case, cover element 2 is formed in the same way as intermediate elements 4. In this case, the structure of cover element 2 and second intermediate element 4 is a double ring structure as shown in FIG. 4B. A retaining plate 3 is there finally connected to cover element 2, and the corresponding filter bag is thus obtained.

Numerous advantages can be obtained with the bag shape described.

The bag can be folded up to save space and is still easy to insert. It is not necessary to unfold it before inserting it.

The bag unfolds automatically and only in the axial direction. The type of folding and fixation of the folds prevents the expansion in the radial direction.

The number of folds and the depth of the folds in combination with the length of the available installation space determines the usable surface of the bag.

Removal is very easy because the diameter of the bag does not increase with use.

The number of folds can be changed to adapt to the material thickness. Thinner materials can be processed with more folds than more voluminous materials.

The usable volume of the bag is also influenced by the depth of the folds

Retaining plate 3 can have a semi-automated or fully automated closure.

Intermediate elements 4 can be made of different materials. The different filter properties can be advantageous for facilitating certain flow paths or for making them more difficult.

Base element 1 of the bag can be made of a structured plastic material that is e.g. permeable to air due to perforation. This prevents the extraction from being blocked. The full filter surface remains usable.

Alternatively, the base surface can be made of material with a particularly high collection capacity.

The bag can have various shapes. The cross sections can be round, oval, angular, star-shaped This is defined only by the die.

More complex bag shapes can also be realized by combining different diameters or shapes. For example, conical bags or asymmetrical shapes can be formed.

An exemplary manufacturing method for a vacuum cleaner filter bag described above comprises the steps of:

arranging two filter material elements on top of each other. This can be done by folding a web of filter material. Alternatively, two filter material webs can also be unwound on top of one another. The sides of the material laminates containing a collection layer point towards each other.

For the combination of the base element and the first intermediate element, only one hole is introduced into a filter material element. In the case of the intermediate elements and the cover element, the center hole is punched into both filter material elements.

The two filter material elements can be connected to one another by welding the outer contour of the later intermediate elements to one another. The adhesive region or the welding region can be pre-compacted.

The intermediate elements, the cover element, and the base element are punched out.

The number of pairs of elements required for the bag shape are successively adhesively bonded or welded to one another The connection surface can again be pre-compacted. Finally or initially, the retaining plate is adhesively bonded or welded on.

It goes without saying that the features mentioned in the embodiments described above are not restricted to this specific combination of features, but are also possible in any other random combination. Furthermore, it goes without saying that the geometries shown in the figures are only by way of example and are also possible in any other random configuration.

1. A vacuum cleaner filter bag comprising:
a base element;
a cover element, where an inflow opening is provided in said cover element and a retaining plate surrounding said inflow opening at least in part is connected to said cover element; and
at least four intermediate elements which are arranged between said base element and said cover element and each comprise a passage opening which is in alignment with said inflow opening of said cover element;
where said intermediate elements are configured as filter elements and each comprise nonwoven material and/or fibrous nonwoven;
where said intermediate element directly adjoining said base element is connected to said base element along an outer edge of said intermediate element or along an edge of said passage opening; and
where adjacent intermediate elements are connected to each other alternately along said edge of said passage openings and along their outer edge.

2. The vacuum cleaner filter bag according to claim 1, where said intermediate elements are formed to be congruent.

3. The vacuum cleaner filter bag according to claim 1, where said cover element is formed to be congruent with said intermediate elements.

4. The vacuum cleaner filter bag according to claim 1, where an outer contour of said base element corresponds to that of said cover element and said intermediate elements.

5. The vacuum cleaner filter bag according to claim 1, where said base element is impermeable to air and/or has a surface profile, wherein the surface profile comprises one or more elevations positioned on a side facing away from an interior of said bag.

6. The vacuum cleaner filter bag according to claim 1, where the ratio of the maximum expansion of said intermediate elements to the diameter of said respective passage opening is at most 4.

7. The vacuum cleaner filter bag according to claim 1, where said intermediate elements are formed to be disk-shaped.

8. The vacuum cleaner filter bag according to claim 1, where said base element is formed to be transparent.

9. The vacuum cleaner filter bag according to claim 1, where an element permeable to air is connected to said base element on a side facing away from a bag content, where said element permeable to air is formed over the entire surface or in a discontinuous manner.

10. The vacuum cleaner filter bag according to claim 1, where said retaining plate comprises a closure element for closing said inflow opening.

11. The vacuum cleaner filter bag according to claim 1, where said intermediate elements are configured to be different.

12. A method for the manufacture of a vacuum cleaner filter bag comprising the steps of:
providing a base element;
providing at least four intermediate elements each comprising a passage opening, where said intermediate elements are configured as filter elements and each comprise nonwoven material and/or fibrous nonwoven;
connecting a first intermediate element to said base element along an outer edge of said intermediate element or along said edge of said passage opening;
connecting the remaining intermediate elements among each other and to said first intermediate element such that adjacent intermediate elements are connected to one another alternately along said edge of said passage openings and along their outer edge, where said passage openings are in alignment with one another.

13. The method according to claim 12, further comprising providing a cover element, where an inflow opening is provided in said cover element, and connecting said cover element to a second of said intermediate elements so that said inflow opening is in alignment with said passage opening of said intermediate element.

14. The method according to claim 12, further comprising pre-compacting connecting regions of said intermediate elements, said base element, and/or said cover element.

15. The method according to claim 13, where the method further comprises first connecting said intermediate elements to one another in pairs along their outer edge excluding said first and said second intermediate element, and then connecting said intermediate elements previously connected in pairs along said edge of said passage openings among each other or to said first or second intermediate element.

16. The vacuum cleaner filter bag of claim 6, wherein the diameter of said respective passage opening is at most 3.

17. The vacuum cleaner filter bag of claim 7, wherein said intermediate elements have a circular, oval, or angular cross section.

18. The vacuum cleaner filter bag of claim 11, wherein the said intermediate elements are comprised of different materials and/or have different material parameters.
